(19) United States
(12) Patent Application Publication
(10) Pub. No.: US 2025/0323308 A1
(43) Pub. Date: Oct. 16, 2025

(54) ROTARY SEPARATOR SUPPLY, ELECTRODE PLATE STACKING APPARATUS INCLUDING SAME, AND ELECTRODE PLATE STACKING METHOD USING SAME

(71) Applicant: SAMSUNG SDI CO., LTD., Yongin-Si (KR)

(72) Inventors: Heonhee KIM, Yongin-Si (KR); Seungyeol Yoo, Yongin-Si (KR); Bo Hyun KIM, Yongin-Si (KR); Hyeokjoo KIM, Yongin-Si (KR); Duckhyun KIM, Yongin-Si (KR); Woonsuk JANG, Yongin-Si (KR)

(21) Appl. No.: 18/908,484

(22) Filed: Oct. 7, 2024

(30) Foreign Application Priority Data
Apr. 12, 2024 (KR) 10-2024-0049648

(51) Int. Cl. H01M 10/04; B65G 47/80

(52) U.S. Cl. CPC H01M 10/0459; B65G 47/80; H01M 10/0404

(57) ABSTRACT

A rotary separator supply including: a disc structure to rotate about a rotary shaft, and including a plurality of slots in a surface thereof; a plurality of separator supply ends located above the disc structure, and to supply separators to the slots, respectively; and a driving member connected to the disc structure, and to reciprocally rotate the disc structure by a circumferential distance to repeatedly move the separators in a folding direction perpendicular to the slots.

### CROSS REFERENCE TO RELATED APPLICATION

The present application claims priority to and the benefit of Korean Patent Application No. 10-2024-0049648, filed on Apr. 12, 2024, in the Korean Intellectual Property Office, the entire disclosure of which is incorporated by reference herein.

### BACKGROUND

### 1. Field

Aspects of embodiments of the present disclosure relate to a rotary separator supply, an electrode plate stacking apparatus including the rotary separator supply, and an electrode plate stacking method using the electrode plate stacking apparatus.

### 2. Description of the Related Art

Recently, there has been a growing interest in high-capacity secondary batteries to replace fossil-fueled internal combustion engines, as well as for use in small electronic devices, such as mobile devices.

In general, high-capacity secondary batteries may each include an electrode plate stack structure in which a plurality of positive and negative electrode plates are alternately stacked, with an intervening separator therebetween to be separated from each other by the separator.

An electrode plate stacking apparatus for manufacturing the electrode plate stack structure includes a separator supply, a stacking stage disposed below the separator supply to clamp a separator, and electrode plate supplies disposed on opposite sides of the stacking stage to alternately supply positive and negative electrode plates to respective surfaces of the clamped separator.

The above information disclosed in this Background section is for enhancement of understanding of the background of the present disclosure, and therefore, it may contain information that does not constitute related (or prior) art.

### SUMMARY

Generally, in a case where a separator is supplied from above to the stacking stage and is clamped, a positive electrode plate may be supplied from the positive electrode plate supply to cover one surface of the separator on the stacking stage. After the supplying of the positive electrode plate is complete, a negative electrode plate may be supplied from the opposite negative electrode plate supply while folding the separator. Thereafter, a desired number of positive and negative electrode plates may be alternately stacked, while folding the separator in a zigzag shape to form an electrode plate stack structure.

In the electrode plate stacking apparatus described above, the stacking stage, the upper-positioned separator supply, and the side-positioned electrode plate supplies may be provided integrally with each other. Therefore, in order to increase a capacity for manufacturing the electrode plate stack structures, it may be desirable to increase the number of electrode plate stacking apparatuses.

However, increasing the number of electrode plate stacking apparatuses may be accompanied with a larger installation area and excessive costs. Therefore, a manufacturing capacity for the electrode plate stack structures may be increased, but a manufacturing process efficiency may remain the same or may be decreased, thereby making it difficult to reduce the costs of secondary cells.

Accordingly, an electrode plate stacking apparatus (e.g., a single electrode plate stacking apparatus) that is able to increase the manufacturing capacity for the electrode plate stack structures may be desired.

One or more embodiments of the present disclosure may be directed to a rotary membrane feeder capable of supplying a plurality of separation membranes concurrently (e.g., at the same or substantially the same time) as each other.

One or more embodiments of the present disclosure may be directed to an electrode plate stack device capable of forming a plurality of electrode plate stack structures concurrently (e.g., simultaneously or substantially simultaneously) with each other by including the rotary membrane feeder.

One or more embodiments of the present disclosure may be directed to an electrode plate stacking method for concurrently (e.g., simultaneously or substantially simultaneously) stacking a plurality of electrode plates using the electrode plate stacking device.

These and other aspects and features of the present disclosure will be described in or will be apparent from the following description of embodiments of the present disclosure.

According to one or more embodiments of the present disclosure, a rotary separator supply includes: a disc structure configured to rotate about a rotary shaft, and including a plurality of slots in a surface thereof; a plurality of separator supply ends located above the disc structure, and configured to supply separators to the slots, respectively; and a driving member connected to the disc structure, and configured to reciprocally rotate the disc structure by a circumferential distance to repeatedly move the separators in a folding direction perpendicular to the slots.

In an embodiment, the disc structure may include: a ring frame including first meshing teeth extending inward; a hollow disc including: outer meshing teeth extending outward, and configured to mesh with the first meshing teeth; inner meshing teeth on an inner open area to extend inward; and the slots; and a center disc including second meshing teeth on outer portions and configured to mesh with the inner meshing teeth, the center disc being configured to close the inner open area and allow the rotary shaft to extend through a central portion thereof.

In an embodiment, the slots may include a plurality of line slots extending in a line shape in a radial direction of the hollow disc, and spaced from and aligned with each other at equal angles.

In an embodiment, the line slots may extend in the radial direction of the hollow disc to a length corresponding to a width of the separators.

In an embodiment, a rotation angle of the outer meshing teeth with respect to a rotation angle of the inner meshing teeth may be defined, so that the outer meshing teeth and the inner meshing teeth may have a same circumferential distance as each other, according to:

$${θ}_{in} = \frac{{r}_{1} + {r}_{2}}{{r}_{1}} {θ}_{out} ,$$

where θᵢₙ indicates the rotation angle of the inner meshing teeth, θₒᵤₜ indicates the rotation angle of the outer meshing teeth, r₁ indicates a radius of the center disc, and r₂ indicates a radial width of the hollow disc.

In an embodiment, a width of the inner meshing teeth may be larger than a width of the outer meshing teeth.

In an embodiment, the driving member may include a fastening end connected to a side portion of the disc structure, and a link structure coupled to the fastening end.

In an embodiment, the link structure may include at least one of a crank-rocker link or a slide link.

In an embodiment, the disc structure may include a plurality of disc structures that are aligned in parallel with each other in a horizontal direction, and the driving member may further include a horizontal connecting link connecting the disc structures to each other in the horizontal direction, the horizontal connecting link being coupled to the fastening end to apply a same rotational force to each of the disc structures.

In an embodiment, the disc structure may include a plurality of disc structures that are aligned in parallel with each other in a vertical direction as a vertically aligned group, and the driving member may further include a vertical connecting link connecting the disc structures to each other in the vertical direction to form the vertically aligned group, the vertical connecting link being coupled to the fastening end to apply a same rotational force to each of the disc structures.

According to one or more embodiments of the present disclosure, an electrode plate stacking apparatus includes: a rotary separator supply configured to rotate in a cycle, and supply a plurality of separators through a plurality of slots to fold the separators; a plurality of stacking stages located below the slots, respectively, and configured to initially fix the separators passing through the slots; and electrode plate supplies, each located at side portions of a corresponding stacking stage of the stacking stages and configured to alternately supply positive electrode plates and negative electrode plates to surfaces of a corresponding separator of the separators that is folded in a zigzag shape. The stacking stages are configured to receive a plurality of the positive electrode plates and a plurality of the negative electrode plates separated from each other by the separators and stacked thereon.

In an embodiment, the rotary separator supply may include: a disc structure configured to rotate about a rotary shaft, and including the slots in a surface thereof; a plurality of separator supply ends located above the disc structure, and configured to supply the separators to the slots, respectively; and a driving member connected to the disc structure, and configured to reciprocally rotate the disc structure by a circumferential distance to repeatedly move the separators in a folding direction perpendicular to the slots.

In an embodiment, the disc structure may include: a ring frame including first meshing teeth extending inward; a hollow disc including outer meshing teeth configured to mesh with the first meshing teeth, inner meshing teeth on an inner open area to extend inward, and the slots; and a center disc including second meshing teeth on outer portions and configured to mesh with the inner meshing teeth, the center disc being configured to close the inner open area and allow the rotary shaft to extend through a central portion thereof. A rotation angle of the outer meshing teeth with respect to a rotation angle of the inner meshing teeth may be defined, so that the outer meshing teeth and the inner meshing teeth may have a same circumferential distance as each other, according to:

$${θ}_{in} = \frac{{r}_{1} + {r}_{2}}{{r}_{1}} {θ}_{out} ,$$

where θᵢₙ muicates the rotation angle of the inner meshing teeth, θₒᵤₜ indicates the rotation angle of the outer meshing teeth, r₁ indicates a radius of the center disc, and r₂ indicates a radial width of the hollow disc.

In an embodiment, the driving member may include a fastening end connected to a side portion of the disc structure, and a link structure coupled to the fastening end.

In an embodiment, the stacking stages may include first to fourth stages aligned in a clockwise direction to be spaced from each other, and corresponding to first to fourth slots from among the plurality of slots that are spaced from each other at an angle of 90° and located sequentially in the clockwise direction, and the electrode plate supplies may include: a first supply located on opposite sides of the first stage, and configured to alternately supply the positive electrode plates and the negative electrode plates; a second supply located on opposite sides of the second stage, and configured to alternately supply the positive electrode plates and the negative electrode plates; a third supply located on opposite sides of the third stage, and configured to alternately supply the positive electrode plates and the negative electrode plates; and a fourth supply located on opposite sides of the fourth stage, and configured to alternately supply the positive electrode plates and the negative electrode plates.

In an embodiment, the electrode plate stacking apparatus may further include: a first positive electrode tray adjacent to the first stage and the fourth stage, and configured to supply the positive electrode plates concurrently to the first stage and the fourth stage; a first negative electrode tray adjacent to the first stage and the second stage, and configured to supply the negative electrode plates concurrently to the first stage and the second stage; a second positive electrode tray adjacent to the second stage and the third stage, and configured to supply the positive electrode plates concurrently to the second stage and the third stage; and a second negative electrode tray adjacent to the third stage and the fourth stage, and configured to supply the negative electrode plates concurrently to the third stage and the fourth stage.

In an embodiment, the electrode plate supplies may include a synchronizer configured to synchronize an operation signal with the disc structure to supply one of the positive electrode plate or the negative electrode plate while the disc structure is rotating.

According to one or more embodiments of the present disclosure, an electrode plate stacking method includes: supplying a plurality of separators concurrently through a plurality of slots of a rotatable disk structure; initially fixing the separators, each of the separators corresponding to one of a plurality of stacking stages located below the slots; rotating the disc structure forward by a folding angle to fold the separators concurrently with each other to cover the stacking stages; supplying first electrode plates concurrently to first surfaces of the separators, respectively, while the separators are being folded; rotating the disc structure backward by the folding angle to fold the separators concurrently with each other to cover the first electrode plates; and supplying second electrode plates concurrently to second surfaces of the separators, respectively.

In an embodiment, the rotating of the disc structure forward, the supplying of the first electrode plates, and the rotating of the disc structure backward may be performed concurrently with each other.

In an embodiment, the first electrode plates may include positive electrode plates that may be supplied concurrently to a pair of adjacent positive electrode supplies, and the second electrode plates may include negative electrode plates that may be supplied concurrently to a pair of adjacent negative electrode supplies.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates a schematic diagram of a rotary separator supply according to one or more embodiments of the present disclosure.

FIG. 2 illustrates a perspective diagram showing a disc structure shown in FIG. 1.

FIG. 3 illustrates an exploded diagram showing components of the disc structure shown in FIG. 2.

FIG. 4 illustrates a schematic diagram of a meshing teeth configuration for providing the same circumferential distance at an outer edge and an inner edge of a hollow disc shown in FIG. 3.

FIG. 5 illustrates an embodiment of the rotary separator supply shown in FIG. 1.

FIG. 6 illustrates an embodiment of the rotary separator supply shown in FIG. 1.

FIG. 7 illustrates a schematic diagram of an electrode plate stacking apparatus including the rotary separator supply shown in FIG. 1 according to one or more embodiments of the present disclosure.

FIG. 8 illustrates a block schematic diagram showing an arrangement of stacking stages and electrode plate supplies of the electrode plate stacking apparatus shown in FIG. 7.

FIG. 9 schematically illustrates various processes of a method of manufacturing electrode plate stack structures in the electrode plate stacking apparatus shown in FIG. 7.

FIG. 10 illustrates an embodiment of the electrode plate stacking apparatus shown in FIG. 7.

FIG. 11 illustrates an embodiment of the electrode plate stacking apparatus shown in FIG. 7.

FIG. 12 illustrates a flowchart showing an electrode plate stacking method using the electrode plate stacking apparatus shown in FIGS. 7 and 8 according to one or more embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

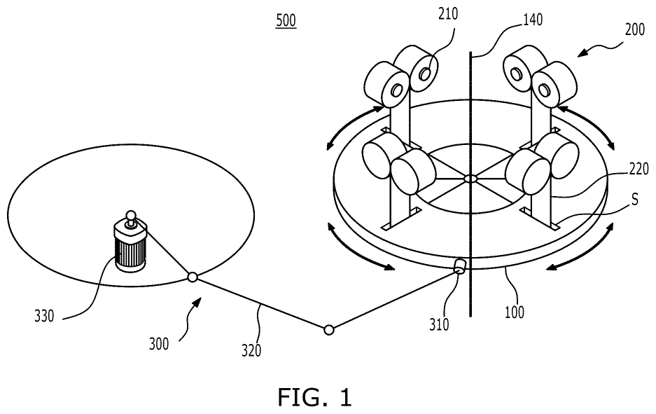

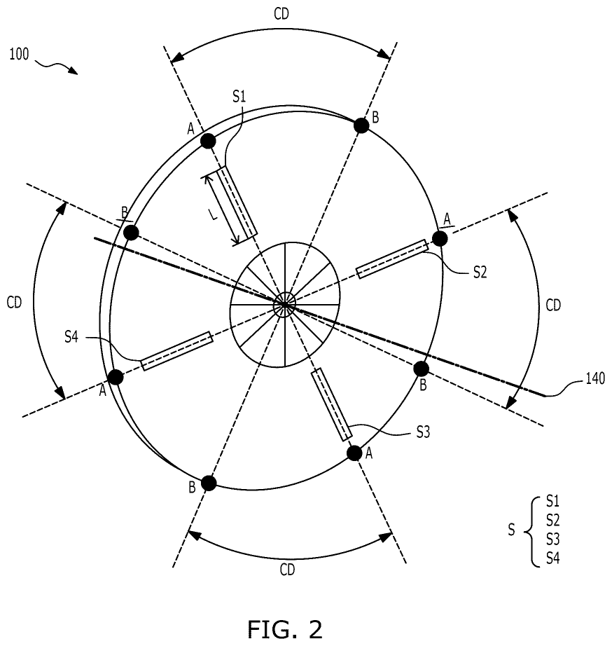

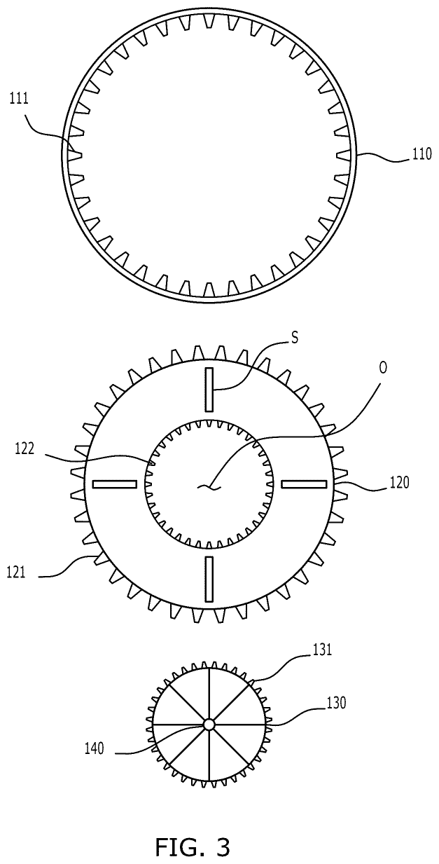

FIG. 1 illustrates a schematic diagram of a rotary separator supply according to one or more embodiments of the present disclosure. FIG. 2 illustrates a perspective diagram showing a disc structure shown in FIG. 1. FIG. 3 illustrates an exploded diagram showing components of the disc structure shown in FIG. 2.

Referring to FIGS. 1 to 3, a rotary separator supply 500 according to some embodiments of the present disclosure may include a disc structure 100, separator supply ends 200, and a driving member 300 to drive the disc structure 100.

In an embodiment, the disc structure 100 may be rotated about a rotary shaft 140 by the driving member 300, and may have a plurality of through slots (e.g., hereinafter, referred to as “slots”) S in a surface to downwardly guide separators 220 supplied from the separator supply ends 200 positioned thereabove.

For example, the disc structure 100 may include a ring frame 110 having first meshing teeth 111 disposed to extend inwardly, a hollow disc 120 including outer meshing teeth 121 extending outwardly to engage with the first meshing teeth 111, inner meshing teeth 122 provided on an inner open area O to extend inwardly, the slots S, and a center disc 130 including second meshing teeth 131 provided on outer portions thereof to engage with the inner meshing teeth 122. The center disc 130 may close the inner open area O, and may allow the rotary shaft 140 to extend through the center thereof.

The ring frame 110 may include (e.g., may be made of) a suitable material having a sufficient strength to define and maintain the outer shape of the disc structure 100. For example, the ring frame 110 may include (e.g., may be made of) a light metal, such as aluminum, or a plastic having a sufficient strength.

On the inner portion of the ring frame 110, the first meshing teeth 111 positioned to extend inwardly may be regularly spaced from each other. The first meshing teeth 111 may include gear teeth.

However, the present disclosure is not limited thereto, and various suitable electromechanical elements may be arranged as long as the hollow disc 120 is movable relative to the ring frame 110.

The hollow disc 120 may have the inner open area O in the central portion thereof, and may include the outer meshing teeth 121 and the inner meshing teeth 122 provided on the outer and inner surfaces thereof. The outer meshing teeth 121 may engage with the first meshing teeth 111 to transmit a relative motion of the hollow disc 120 with respect to the ring frame 110. The inner meshing teeth 122 may engage with the second meshing teeth 131 provided on the outer portion of the center disc 130 to transmit a relative motion of the center disc 130 with respect to the hollow disc 120.

Therefore, as described in more detail below, an outer meshing teeth configuration of the first meshing teeth 111 and the outer meshing teeth 121 and an inner meshing teeth configuration of the second meshing teeth 131 and the inner meshing teeth 122 may be configured (e.g., may be set) differently from each other to minimize or reduce a deviation (e.g., a variation) in circumferential distances at the outer and inner edges of the hollow disc 120 having different radii from each other.

The slots S may include a plurality of line slots extending in a shape of a line in the radial direction of the hollow disc 120, and spaced apart from and aligned at the same angle as each other.

In other words, the slots S may be provided in a shape of the open area O penetrating the surface of the hollow disc 120 in a line shape, and a plurality of separators 220 may pass through the slots S, respectively, and extend to positions below the disc structure 100.

In the present embodiment, the slots S may include four line slots that are spaced apart from each other at an angle of 90°.

The separator supply ends 200 may guide the separators 220 supplied from supply reels to the disc structure 100 using a plurality of feed rollers 210.

The separators 220 may each be a thin film for electrically separating a positive electrode plate and a negative electrode plate for a secondary battery from each other, and may include a substrate including (e.g., made of) a flexible material, and a coating layer surrounding around the substrate. For example, the substrate may be implemented as a flexible film of polyethylene, polypropylene, or the like, and the coating layer may include an inorganic compound, such as ceramic.

The separators 220 having the above-described configuration may be supplied to the electrode plate stacking apparatus, described in more detail below, while wound on the supply reels.

For convenience of illustration, the feed rollers 210 are described as a single means in the present embodiment, but the present disclosure is not limited thereto. In other words, the separator supply ends 200 may supply the separators 220 to the disc structure 100 from the supply reels through various suitable conveying means as would be understood by those having ordinary skill in the art.

In this case, the separator supply ends 200 may be disposed for the slots S, respectively. The separator supply ends 200 may be provided in a number corresponding to the number of the slots S of the single disc structure 100.

In other words, the separator supply ends 200 may be disposed through the single disc structure 100, and the electrode plates corresponding to the slots S, respectively, may be stacked under the disc structure 100.

Because the electrode plate stack may be configured such that the alternating positive and negative electrode plates are separated from each other by the separators, a process of stacking the electrode plates may include a process of folding the separators in a zigzag shape.

In the present embodiment, the process of folding the separators may be performed by rotating the disc structure 100. The disc structure 100 may be driven by the driving member 300 described in more detail below to rotate reciprocally from the slots S in a clockwise or counterclockwise direction at a desired folding angle (e.g., a predetermined folding angle). In response to the rotation of the disc structure 100, the separators 220 inserted in the slots S are moved concurrently (e.g., at the same or substantially at the same time) with each other by a circumferential distance corresponding to the folding angle.

Thus, in response to the reciprocal rotation of the disc structure 100, the separators 220 inserted in the slots S, respectively, are folded at a position where the direction of rotation changes while being reciprocated by the circumferential distance.

Accordingly, the folding process for a plurality of separators may be performed concurrently (e.g., at the same or substantially at the same time) with each other by reciprocally rotating the single disc structure 100. In a case where electrode plate supplies for supplying electrode plates to the separators 220, respectively, are provided, the manufacturing capacity for the electrode plate stack structures may be increased by a multiple corresponding to the number of the slots S.

In this case, because the slots S are disposed in the radial direction of the hollow disc 120, the circumferential distance may vary depending on the position thereof in the radial direction. In a case where the circumferential distance varies depending on the radius of the hollow disc 120, the separators 220 inserted into the slots S and moved therethrough may have different travel distances in the width direction, thereby resulting in wrinkling.

Accordingly, in the present embodiment, the meshing teeth configurations on the outer edge and the inner edge of the hollow disc 120 may be different from each other in order to enforce the same or substantially the same circumferential distance for folding angles at the outer edge and the inner edge of the hollow disc 120.

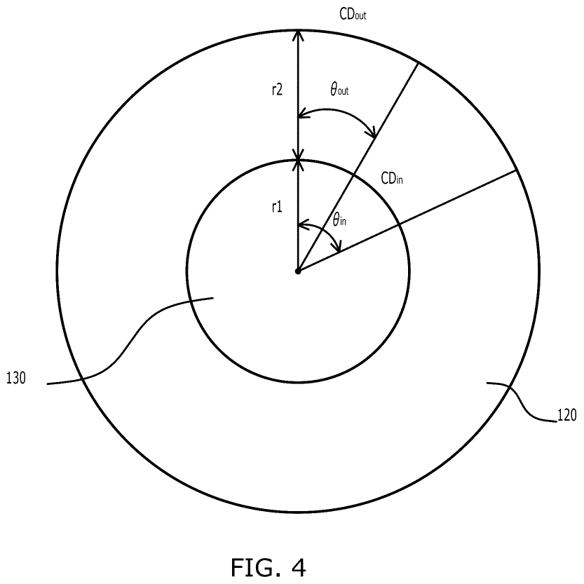

FIG. 4 illustrates a schematic diagram of a meshing teeth configuration for providing the same circumferential distance at the outer edge and the inner edge of the hollow disc shown in FIG. 3.

Referring to FIG. 4, in a case where the hollow disc 120 is rotated by the same folding angle θ, the circumferential distance CDₒᵤₜ of the outer edge of the hollow disc 120 is defined by Equation 1, and the inner circumferential distance CDᵢₙ of the inner edge of the hollow disc 120 is defined by Equation 2.

$${CD}_{out} = ( {r}_{1} + {r}_{2} ) θ \qquad Equation 1$$

$${CD}_{in} = {r}_{1} θ \qquad Equation 2$$

Thus, in the case where the disc structure 100 is rotated by the same folding angle, each of the separators 220 may have different travel distances at the outer edge and the inner edge of the hollow disc 120, thereby forming wrinkles in the width direction of the separator 220.

Therefore, in order to prevent or substantially prevent the wrinkles from occurring at the outer edge and the inner edge of the hollow disc 120, in some embodiments, the circumferential distances at the outer edge and the inner edge may be configured (e.g., may be set) to be the same or substantially the same as each other. Accordingly, the meshing teeth may be configured so that the angles of movement at the outer edge and the inner edge of the hollow disc 120 may be different from each other even in a case where a single driving force is applied to the disc structure 100 by the driving member 300.

In order for the circumferences at the inner and outer edges of the hollow disc 120 to be the same or substantially the same as each other due to the single driving force, the inner rotation angle θᵢₙ at the inner edge and the outer rotation angle θₒᵤₜ may be configured to satisfy a relationship defined in Equation 3 below.

In other words, the inner meshing teeth 122 and the outer meshing teeth 121 of the hollow disc 120 may be configured to satisfy Equation 3 below, so that the circumferential distances that are traveled are the same or substantially the same as each other due to the difference in the rotation angles.

$${θ}_{in} = \frac{{r}_{1} + {r}_{2}}{{r}_{1}} {θ}_{out} \qquad Equation 3$$

In Equation 3, θᵢₙ indicates the rotation angle of the inner meshing teeth, θₒᵤₜ indicates the rotation angle of the outer meshing teeth, r₁ indicates the radius of the center disc, and r₂ indicates a radial width of the hollow disc.

Accordingly, the tooth width of the inner meshing teeth 122 may be larger than the tooth width of the outer meshing teeth 121, thereby allowing a larger rotation angle to be used for the same driving force.

FIG. 4 shows that the configurations of the inner meshing teeth 122 and the outer meshing teeth 121 are changed, and thus, the wrinkling that may be caused by the deviation in the circumferential distances of the separator 220 may be further reduced in a case where a plurality of meshing teeth are provided on the hollow disc 120 from the inner edge to the outer edge.

In some embodiments, in a case where the ring frame 110, the center disc 130, and the hollow disc 120 are implemented as a ring gear, a sun gear, and a planetary gear, respectively, a deviation in the widthwise travel distances of the separator 220 through the slots S may be minimized or reduced.

Referring back to FIGS. 1 to 3, the driving member 300 may include a fastening end 310 connected to a side portion of the disc structure 100, a linkage structure 320 connected to (e.g., coupled to or attached to) the fastening end 310, and a power source 330 to provide power to the linkage structure 320.

The fastening end 310 may be directly fixed to the disc structure 100, or may be connected to the disc structure 100 by an intermediate means. For example, the fastening end 310 may include a pivoting joint that is rotatably fixed to a side portion of the disc structure 100.

The linkage structure 320 may be a motorized structure that transmits the driving force transmitted from the power source 330 to the fastening end 310, and may control rotational and circular motions. In the present embodiment, the linkage structure 320 may be implemented as either a crank-rocker linkage in which a rocker serving as a linkage point performs a reciprocal circular motion by 360° rotation of a crank serving as a driving part, or a slide linkage provided with a slide to perform a linear motion in place of the rocker.

The power source 330 may be fixed to the base on which the separator supply 500 is disposed to provide the linkage structure 320 with the driving force to rotate the disk structure 100. In the present embodiment, the power source 330 may be implemented as a programmable logic controller (PLC) motor. However, the present disclosure is not limited thereto, and it will be appreciated by those having ordinary skill in the art that the power source 330 may be provided in a variety of suitable manners depending on the desired characteristics of the linkage structure 320.

Accordingly, the separator supply ends 200 that supply the separators 220 passing through the slots S may perform the separator folding operation concurrently (e.g., at the same or substantially at the same time) with each other in response to the reciprocal rotation of the single disc structure 100. Thus, a plurality of electrode plate stacking processes, each including the separator folding process, may be performed concurrently (e.g., at the same or substantially at the same time) with each other.

For example, in a case where four slots S are provided, four different electrode plate stacking processes may be performed concurrently with each other, thereby increasing the electrode plate stack manufacturing capacity by fourfold.

The electrode plate stacking processes that may be performed concurrently (e.g., at the same or substantially at the same time) with each other may be variously adjusted depending on the desired combination of the disc structures 100.

By adjusting the number of the slots S provided in the disc structure 100, or by aligning the disc structures 100 with each other in the horizontal direction or in the vertical direction, the number of the electrode plate stacking processes that are performed concurrently (e.g., at the same or substantially at the same time) with each other may be adjusted as needed or desired (e.g., may be freely adjusted).

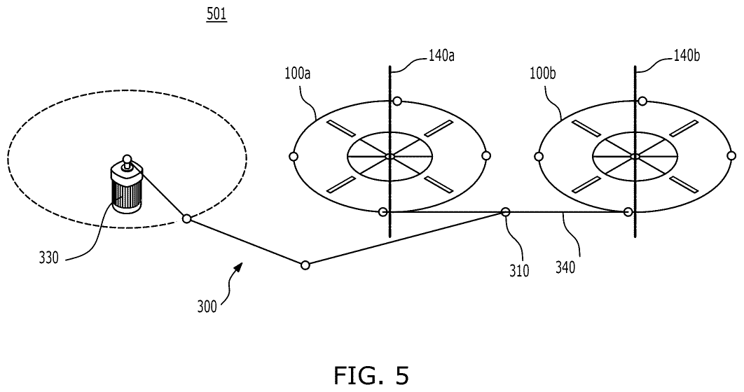

FIG. 5 illustrates an embodiment of the rotary separator supply shown in FIG. 1.

Referring to FIG. 5, the rotary separator supply 501 according to some embodiments of the present disclosure may include a plurality of disc structures 100a and 100b that are aligned side-by-side with each other in the horizontal direction.

In this case, the driving member 300 may include a horizontal connecting link 340 to connect the disc structures 100a and 100b to each other in the horizontal direction, and the horizontal connecting link 340 may be connected to (e.g., coupled to or attached to) the fastening end 310. The horizontal connecting link 340 may be a link connecting the side-by-side aligned disc structures 100a and 100b to each other, and may enable the disc structures 100a and 100b to operate in a single unit of operation.

The fastening end 310 may be disposed on the horizontal connecting link 340, and the linkage structure 320 may transmit a driving force through the horizontal connecting link 340. Thus, the driving force may be applied to the horizontal connecting link 340 connecting the disc structures 100a and 100b to each other, rather than to each of the disc structures 100a and 100b, so that the same rotational force may be applied to each of the disc structures 100a and 100b.

Accordingly, a deviation (e.g., a variation) of the respective aligned disc structures 100a and 100b may be minimized or reduced, thereby allowing the disc structures 100a and 100b to function as substantially a single separator supply. In this case, the number of the slots S may be increased by the number of the aligned disc structures 100, thereby exponentially increasing the manufacturing capacity for the electrode plate stack structures.

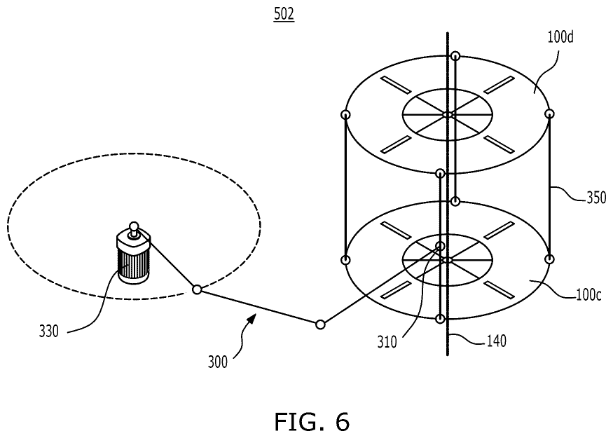

FIG. 6 illustrates an embodiment of the rotary separator supply shown in FIG. 1.

Referring to FIG. 6, the rotary separator supply 502 according to some embodiments of the present disclosure may include a plurality of disc structures 100 that are stacked in the vertical direction.

In this case, the driving member 300 may include a plurality of vertical connecting links 350 to connect the disc structures 100c and 100d to each other in the vertical direction, and at least one of the plurality of vertical connecting links 350 may be connected to (e.g., coupled to or attached to) the fastening end 310. The vertical connecting link 350 may be a link connecting the vertically stacked disc structures 100c and 100d to each other, and may enable the disc structures 100c and 100d to operate in a single unit of operation.

The fastening end 310 may be disposed on the vertical connecting link 350, and the linkage structure 320 may transmit a driving force through the vertical connecting link 350. Thus, the driving force may be applied to the vertical connecting link 350 connecting the disc structures 100c and 100d to each other, rather than to each of the disc structures 100c and 100d, so that the same rotational force may be applied to each of the disc structures 100c and 100d.

Accordingly, a deviation (e.g., a variation) of the respective stacked disc structures 100c and 100d may be minimized or reduced, thereby allowing the disc structures 100c and 100d to operate as a substantially single separator supply. In this case, the number of the slots S may be increased by the number of the stacked disc structures 100, thereby increasing the manufacturing capacity for the electrode plate stack structures.

In more detail, the separator supply 502 according to some embodiments may be configured such that the disc structures 100 are stacked in the vertical direction, and the electrode plate stacking apparatuses for stacking the electrode plates may also be stacked in the vertical direction along the disc structures.

Accordingly, in a case where a lower disc structure 100c and an upper disc structure 100d are stacked in the vertical direction, the electrode plate stacking apparatuses may be disposed below the lower disc structure 100c and between the lower disc structure 100c and the upper disc structure 100d.

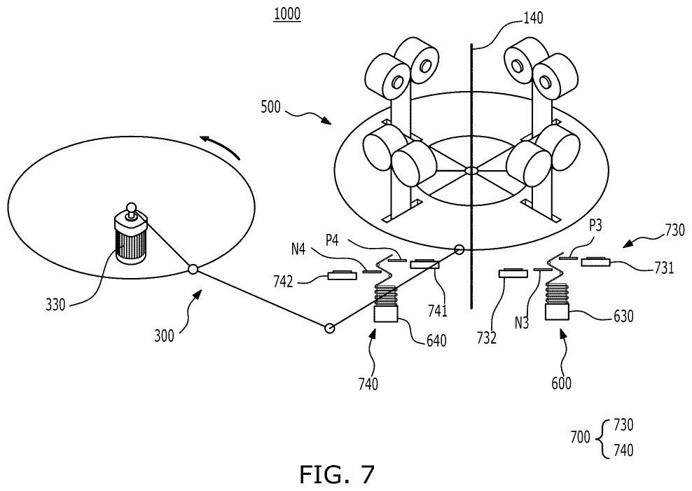

FIG. 7 illustrates a schematic diagram of an electrode plate stacking apparatus including the rotary separator supply shown in FIG. 1 according to one or more embodiments of the present disclosure.

Hereinafter, an electrode plate stacking apparatus 1000 including the rotary separator supply 500 shown in FIGS. 1 to 4 may be described in more detail. Accordingly, the same or substantially the same components as those of the rotary separator supply 500 described above with reference to FIGS. 1 to 4 may be designated with the same reference numerals, and thus, redundant description thereof may not be repeated.

Referring to FIG. 7, the electrode plate stacking apparatus 1000 according to some embodiments of the present disclosure may include the rotary separator supply 500, stacking stages 600, and electrode plate supplies 700.

The electrode plate stacking apparatus 1000 may be used to manufacture a plurality of electrode plate stack structures (PSS) concurrently (e.g., at the same or substantially at the same time) with each other by performing a folding process concurrently (e.g., at the same or substantially at the same time) with each other on the separators 220 supplied by the separator supply 500 using the disc structure 100.

For example, the rotary separator supply 500 may include the rotary disc structure 100 that is configured to rotate about a rotary shaft 140 and has a plurality of slots S in a surface thereof, the plurality of separator supply ends 200 disposed above the disc structure 100 to supply the separators 220 into the slots S, respectively, and the driving member 300 connected to the disc structure 100 to repeatedly rotate the disc structure 100 by a desired circumferential distance (e.g., a predetermined circumferential distance) to repeatedly move the separators 220 in a folding direction perpendicular to or substantially perpendicular to the slots S.

The rotary separator supply 500 has the same or substantially the same configuration as that of the rotary separator supply 500 described above with reference to FIGS. 1 to 4, and therefore, redundant description thereof may not be repeated.

In an embodiment, the stacking stages 600 may be disposed below the slots S, respectively, to initially fix the separators 220 that have passed through the slots S. Further, the electrode plate supplies 700 may be disposed on sides of the corresponding stacking stage 600 to alternately supply positive and negative electrode plates onto the surface of the corresponding separator 220 folded in a zigzag shape.

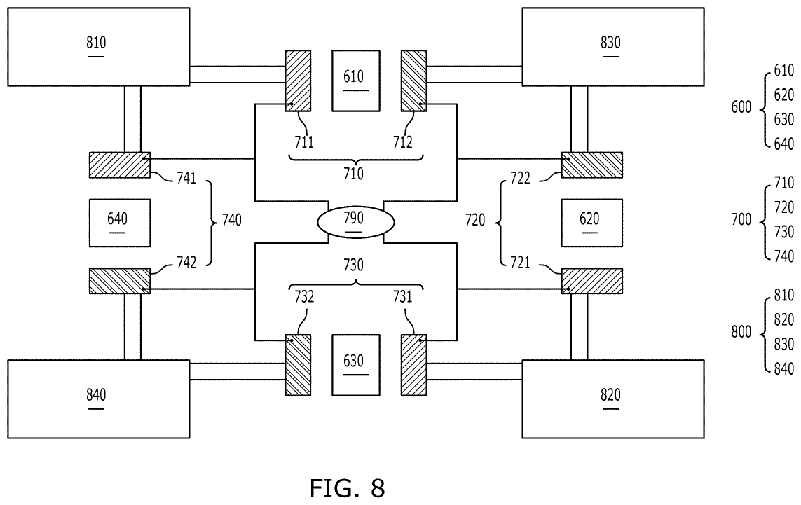

FIG. 8 illustrates a block schematic diagram showing an arrangement of the stacking stages and the electrode plate supplies of the electrode plate stacking apparatus shown in FIG. 7.

Referring to FIG. 8, in some embodiments, the electrode plate stacking apparatus 1000 includes a disc structure 100 having four slots S that are spaced apart from each other at an angle of 90°. Accordingly, the stacking stages 600 may include first to fourth stages 610, 620, 630, and 640 that are aligned in the clockwise direction corresponding to the four slots S.

Referring to FIG. 8, the separators 220 having passed through the respective slots S may be supplied to, and initially clamped by, the first to fourth stages 610, 620, 630, and 640, in which the respective separators (e.g., separator membranes) 220 may be subjected to a folding process concurrently (e.g., at the same or substantially at the same time) with each other by the single disc structure 100.

In this case, the electrode plate supplies 700 may include a first supply 710, a second supply 720, a third supply 730, and a fourth supply 740. The first supply 710 may be disposed on opposite sides of the first stage 610 to alternately supply the positive electrode plates and the negative electrode plates. The second supply 720 may be disposed on opposite sides of the second stage 620 to alternately supply the positive electrode plates and the negative electrode plates. The third supply 730 may be disposed on opposite sides of the third stage 630 to alternately supply the positive electrode plates and the negative electrode plates. The fourth supply 740 may be disposed on opposite sides of the fourth stage 640 to alternately supply the positive electrode plates and the negative electrode plates.

The first supply 710 may include a first positive electrode supply 711 to supply the positive electrode plates onto the surface of the folded separator 220, and a first negative electrode supply 712 to supply the negative electrode plates onto the surface of the folded separator 220. The second supply 720 may include a second positive electrode supply 721 to supply the positive electrode plates onto the surface of the folded separator 220, and a second negative electrode supply 722 to supply the negative electrode plates onto the surface of the folded separator 220.

Similarly, the third supply 730 may include a third positive electrode supply 731 to supply the positive electrode plates onto the surface of the folded separator 220, and a third negative electrode supply 732 to supply the negative electrode plates onto the surface of folded separator 220. The fourth supply 740 may include a fourth positive electrode supply 741 to supply the positive electrode plates onto the surface of the folded separator 220, and a fourth negative electrode supply 742 to supply the negative electrode plates onto the surface of the folded separator 220.

Each time the rotational direction of the disk structure 100 is changed, the four separators 220 are folded concurrently (e.g., at the same or substantially at the same time) with each other. Each time the separators 220 are folded, the positive electrode plates and the negative electrode plates may be alternately supplied onto the separators 220 on the respective stages.

Accordingly, four electrode plate stack structures (PSS) may be formed concurrently (e.g., at the same or substantially at the same time) with each other on the first through fourth stages 610, 620, 630, and 640 in response to the rotation of the single disc structure 100.

In this case, the positions of the positive electrode supply and the negative electrode supply of each stage may be adjusted to minimize or reduce the footprint of electrode plate supply trays 800 of the positive electrode plates and the negative electrode plates that are supplied to each stage.

For example, the electrode plate supply trays 800 may include a first positive electrode tray 810 disposed adjacent to the first stage 610 and the fourth stage 640 to supply the positive electrode plates concurrently (e.g., at the same or substantially at the same time) to the first stage 610 and the fourth stage 640. The electrode plate supply trays 800 may further include a first negative electrode tray 830 disposed adjacent to the first stage 610 and the second stage 620 to supply the negative electrode plates concurrently (e.g., at the same or substantially at the same time) to the first stage 610 and the second stage 620. The electrode plate supply trays 800 may further include a second positive electrode tray 820 disposed adjacent to the second stage 620 and the third stage 630 to supply the negative electrode plates concurrently (e.g., at the same or substantially at the same time) to the second stage 620 and the third stage 630. The electrode plate supply trays 800 may further include a second negative electrode tray 840 disposed adjacent to the third stage 630 and the fourth stage 640 to supply the negative electrode plates concurrently (e.g., at the same or substantially at the same time) to the third stage 630 and the fourth stage 640.

Accordingly, a supply tray area for the positive and negative electrode plates supplied to the stages 610 to 640 positioned adjacent to each other may be minimized or reduced to more efficiently use the space of the electrode plate stack area positioned below the single disc structure 100.

A process for manufacturing an electrode plate stack structure (PSS) using the first stage 610 and the first supply 710 is described in more detail below as a representative example.

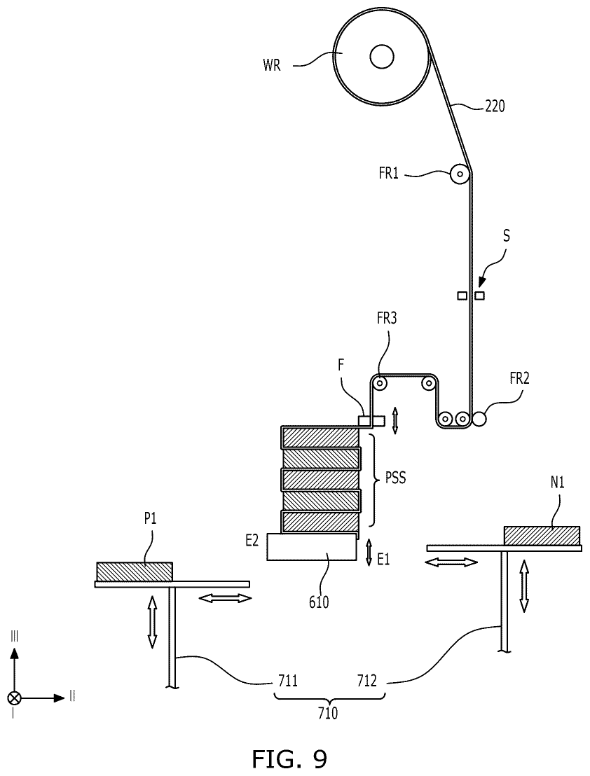

FIG. 9 schematically illustrates various processes of a method of manufacturing an electrode plate stack structure in the electrode plate stacking apparatus shown in FIG. 7.

Referring to FIG. 9, a folding guide F may be moved in a second direction (e.g., the II axis) and a third direction (e.g., the III axis) in the electrode stacking area above the first stage 610 to transform a separator 220 supplied through a slot S into a folded separator for electrode stacking.

The first stage 610 to form the folded separator is disposed below the folding guide F, and electrodes P1 and N1 having different polarities from each other are sequentially placed one after another on the folded separator formed on the first stage 610 to form an electrode plate stack structure (PSS). Accordingly, a vertical space between the folding guide F and the first stage 610 may be provided as an electrode stacking area for electrode stacking.

The separator 220 moves in the second direction (e.g., II axis) while being gradually moved upward in the third direction (e.g., III axis) from the first stage 610 by the folding guide F, and then is placed to be folded into a zigzag shape.

In this case, each time the separator 220 is folded once in a zigzag shape, a positive electrode plate P1 and a negative electrode plate N1 are alternately supplied onto the upper surface of the folded separator from the first supply 710 positioned on sides of the first stage 610. In response to the upward movement of the folding guide F, the folding of the separator 220 and the supplying of the positive electrode plate P1 and the negative electrode plate N1 may be repeated to completely form the electrode plate stack structure PSS on the first stage 610.

In response to the separator 220 that has passed through the slot S being inserted into the folding guide F, the folding guide F guides the separator 220 to the bottom surface of the first stage 610, which is at the bottom of the electrode stacking area.

Subsequently, in a state in which the end of the separator 220 is fixed to a fixing end provided on a first end E1 of the first stage 610, the folding guide F moves in the second direction (e.g., II axis) toward a second end E2 of the first stage 610. The first end E1 and the second end E2 are edge regions of the first stage 610 positioned symmetrically to (e.g., or opposite to) each other in the second direction (e.g., II axis).

Accordingly, the separator 220 is transformed into a first folded separator that is folded to cover the first stage 610, and in response to the first folding operation, the folding guide F is positioned at the second end E2 of the first stage 610.

As the first folding operation is completed, the electrodes are supplied from the first supply 710. The first supply 710 includes the first positive electrode supply 711 to supply the positive electrode plate P1 and the first negative electrode supply 712 to supply the negative electrode plate N1, which are disposed on opposite sides of the first stage 610.

As the first folding operation is completed, the positive electrode plate P1 is supplied from the first supply 710 onto the surface of the folded separator located on the surface of the first stage 610. As the supplying of the positive electrode plate P1 is completed, the folding guide F returns to the first end E1. Accordingly, the positive electrode plate P1 is placed on the separator folded to cover the surface of the first stage 610.

At the time that the folding guide F returns to the first end E1, a flattening guide may flatten the separator 220 according to the surface shape of the positive electrode plate P1 at the position below the folding guide F. Accordingly, the separator 220 is folded to cover the positive electrode plate P1.

During the returning of the folding guide F to the first end E1, the first negative electrode supply 712 supplies the negative electrode plate N1 onto the surface of the folded separator positioned on the positive electrode plate P1. As the supplying of the negative electrode plate N1 is completed, the folding guide F moves back to the second end E2. Accordingly, the negative electrode plate N1 is placed on the separator folded to cover the surface of the positive electrode plate P1.

In addition, while the folding guide F is moved back to the second end E2, the first positive electrode supply 711 supplies an additional positive electrode plate P1, so that the additional positive electrode plate P1 is placed on the folded separator 220 positioned on the surface of the negative electrode plate N1.

The above-described processes may be repeated to obtain the electrode plate stack structure (PSS) including a plurality of positive and negative electrode plates that are stacked alternately and separated from each other by the folded separator located therebetween on the first stage 610.

The electrode plate supply 700 may further include a signal synchronizer 790 (e.g., see FIG. 8) associated with the disc structure 100 to supply one of the positive electrode plate or the negative electrode plate while the disc structure 100 is rotating.

The supplying of the electrode plate may be prepared by detecting a drive signal by which the direction of a rotation of the disc structure 100 is changed. Accordingly, the folding of the separator 220 and the supplying of the electrode plate may be performed automatically.

The signal synchronizer 790 may have a function relationship (e.g., a predetermined functional relationship) between operation signals for the first to fourth supplies 710 to 740 and rotational direction change signals for the disc structure 100.

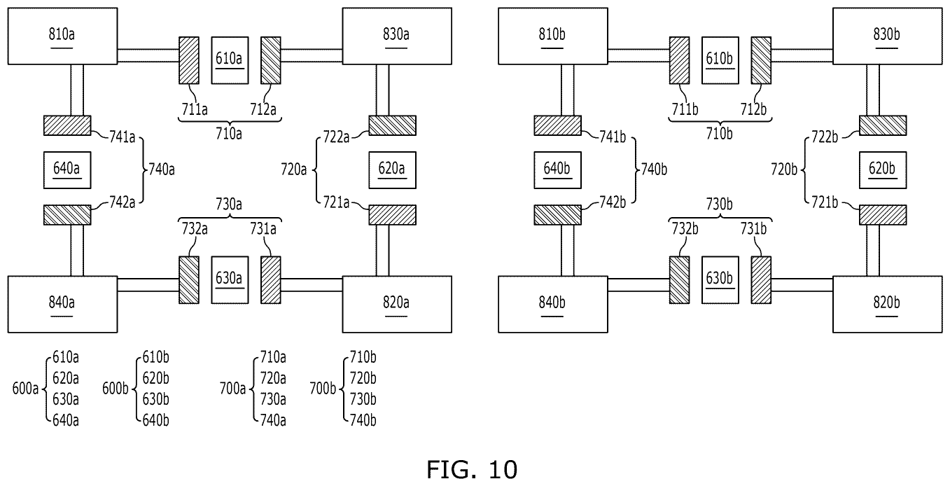

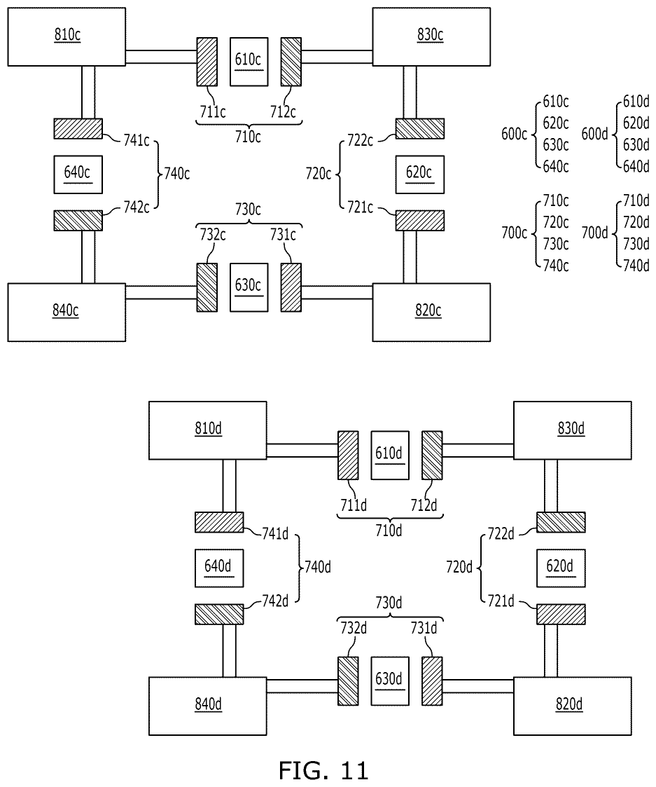

FIG. 10 illustrates an embodiment of the electrode plate stacking apparatus shown in FIG. 7. FIG. 11 illustrates an embodiment of the electrode plate stacking apparatus shown in FIG. 7.

FIG. 10 illustrates stacking stages and electrode plate supplies disposed in an electrode plate stacking apparatus including the rotary separator supplies 501 (e.g., see FIG. 5), and FIG. 11 illustrates stacking stages and electrode plate supplies disposed in an electrode plate stacking apparatus including the rotary separator supplies 502 (e.g., see FIG. 6).

Referring to FIG. 10, pairs of stages 600a and 600b and pairs of electrode plate supplies 700a and 700b may be provided to correspond to the horizontally-aligned disc structures 100, respectively. In other words, an arrangement that is the same as the arrangement of the stacking stages 600 and the electrode plate supplies 700 shown in FIG. 8 is illustrated as added in the horizontal direction.

The supplying of separators 220 by the rotary separator supplies 501 is doubled, and the alignment of the stacking stages 600 and the electrode plate supplies 700 is also doubled. Accordingly, the manufacturing capacity for the electrode plate stack structures (PSS) may be doubled.

Referring to FIG. 11, pairs of stages 600c and 600d and pairs of electrode plate supplies 700c and 700d may be provided to correspond to the vertically aligned disc structures 100. In other words, an arrangement that is the same as the arrangement of the stacking stages 600 and the electrode plate supplies 700 shown in FIG. 8 is illustrated as added in the vertical direction.

The supplying of the separators 220 by the rotary separator supply 502 is doubled, and the alignment of the stacking stages 600 and the electrode plate supplies 700 is also doubled. Accordingly, the manufacturing capacity for the electrode plate stack structures (PSS) may be doubled.

Hereinafter, an electrode plate stacking method using the electrode plate stacking apparatus 1000 will be described in more detail.

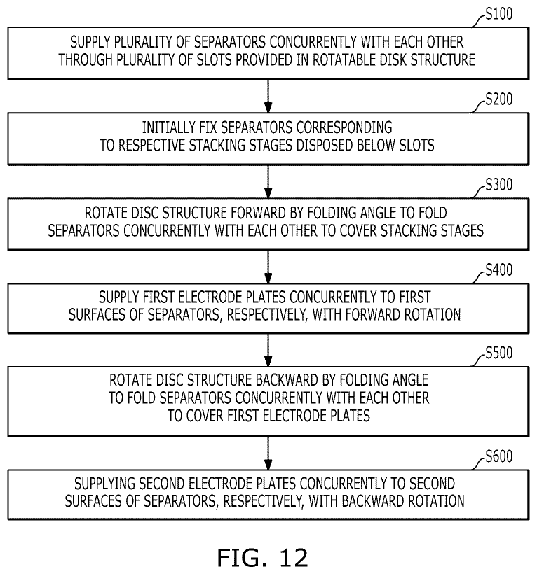

FIG. 12 illustrates a flowchart showing an electrode plate stacking method using the electrode plate stacking apparatus shown in FIGS. 7 and 8 according to one or more embodiments of the present disclosure.

Referring to FIG. 12, a plurality of separators 220 are supplied concurrently (e.g., at the same or substantially at the same time) with each other through a plurality of slots S provided in the rotatable disk structure 100 (S100). The separators 220 unwound from supply reels may be guided to the disc

structure 100 using the feed rollers 210 and guide rollers. In this case, the supply reels, the feed rollers, and the guide rollers may be arranged to supply the separators 220 to the respective slots S provided in the disc structure 100.

Thereafter, the separators 220 corresponding to the stacking stages 600 disposed below the respective slots S are initially fixed (S200).

For example, the stacking stages 600 and the separators 220 may be fixed by hooking the separators 220 on fixed ends that are fixed to edges of the stacking stages 600. Accordingly, each of the separators 220 may be provided as a single linear film that extends from the corresponding supply reel, passes through the corresponding slot S, and is fixed to a side portion of the corresponding stacking stage 600.

Subsequently, the disc structure 100 is rotated forward by the folding angle to fold the separators 220 concurrently (e.g., at the same or substantially at the same time) with each other to cover the stacking stages 600 (S300).

Because the separators are placed to pass through the slots S provided in the single disc structure 100, the separators 220 may be folded concurrently (e.g., at the same or substantially at the same time) with each other by the rotation of the disc structure 100.

In this case, the folding angle of the disc structure 100 is determined so that the circumferential travel distance of the separator 220 due to the folding angle may sufficiently cover the electrode plate.

In this case, the disc structure 100 may include the inner meshing teeth having a larger size than that of the outer meshing teeth positioned on the outer portion of the hollow disc 120 in order to prevent or substantially prevent the separator 220 from folding in the radial direction of the hollow disc 120.

First electrode plates are supplied concurrently (e.g., at the same or substantially at the same time) to the first surfaces of the separators 220, respectively, while the separators 220 are being folded (S400). The electrode plate supplies 700 that separately supply a positive electrode plate and a negative electrode plate are disposed at side portions of the stacking stages 600, and each of the electrode plate supplies 700 may operate in response to the folding of the separator 220 of the corresponding stacking stage 600.

Subsequently, the disc structure 100 is rotated backward by the folding angle to fold the separators 220 concurrently (e.g., at the same or substantially at the same time) with each other to cover the first electrode plates (S500).

As the supplying of the first electrode plate at each stage is completed, the disc structure 100 changes the direction of rotation, and rotates again backwards. In response to the backward rotation of the disc structure 100, the separator 220 is also folded in the opposite direction to cover the first electrode plate supplied to the surface of the separator 220 again. At this time, while the separator 220 is being folded to cover the first electrode plate, the second electrode plate is supplied concurrently (e.g., at the same or substantially at the same time) to the second surfaces of the separators 220, respectively, from the opposite side of the stacking stage 600 (S600).

The process of rotating the disc structure 100 forward and the process of supplying the first electrode plate may be performed concurrently (e.g., at the same or substantially at the same time) with each other, and the process of rotating the disc structure 100 backward and the process of supplying the second electrode plate may be performed concurrently (e.g., at the same or substantially at the same time) with each other.

By performing the operations of the electrode plate supply 700 in concert with a change in the direction of the rotation of the disc structure 100, the electrode plate may be supplied concurrently (e.g., at the same or substantially at the same time) with the folding of the separator 220.

According to some embodiments described above, the separators 220 passing through the slots S provided in the disc structure may be folded concurrently (e.g., at the same or substantially at the same time) with each other in response to the rotation of the single disc structure 100. Accordingly, by providing the stacking stages 600 and the electrode plate supplies 700 corresponding to the slots S, the manufacturing capacity for the electrode plate stack structures may be increased.

In addition, in some embodiments, by adjusting the number of the slots S provided in the disc structure 100 and/or by aligning the disc structures 100 in the horizontal or vertical direction, the number of the electrode plate stacking processes that are performed concurrently (e.g., at the same or substantially at the same time) with each other may be modified as needed or desired (e.g., may be freely adjusted).

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Description of Reference Symbols

| | |
|---|---|
| 100: disc structure | 110: ring frame |
| 120: hollow disc | 130: center disc |
| 200: separator supply end | 210: feed roller |
| 220: separator | 300: driving member |
| 310: fastening end | 320: linkage structure |
| 330: power source | 500: rotary separator supply |
| 600: stacking stage | 700: electrode plate supply |
| 800: electrode plate supply tray | |
| 1000: electrode plate stacking apparatus | |

1 what is claimed is:

1. A rotary separator supply comprising:
a disc structure configured to rotate about a rotary shaft, and comprising a plurality of slots in a surface thereof;
a plurality of separator supply ends located above the disc structure, and configured to supply separators to the slots, respectively; and
a driving member connected to the disc structure, and configured to reciprocally rotate the disc structure by a circumferential distance to repeatedly move the separators in a folding direction perpendicular to the slots.

2. The rotary separator supply as claimed in claim 1, wherein the disc structure comprises:
a ring frame comprising first meshing teeth extending inward;
a hollow disc comprising:
outer meshing teeth extending outward, and configured to mesh with the first meshing teeth;
inner meshing teeth on an inner open area to extend inward; and
the slots; and
a center disc comprising second meshing teeth on outer portions and configured to mesh with the inner meshing teeth, the center disc being configured to close the inner open area and allow the rotary shaft to extend through a central portion thereof.

3. The rotary separator supply as claimed in claim 2, wherein the slots comprise a plurality of line slots extending in a line shape in a radial direction of the hollow disc, and spaced from and aligned with each other at equal angles.

4. The rotary separator supply as claimed in claim 3, wherein the line slots extend in the radial direction of the hollow disc to a length corresponding to a width of the separators.

5. The rotary separator supply as claimed in claim 2, wherein a rotation angle of the outer meshing teeth with respect to a rotation angle of the inner meshing teeth is defined, so that the outer meshing teeth and the inner meshing teeth have a same circumferential distance as each other, according to:
$${θ}_{in} = \frac{{r}_{1} + {r}_{2}}{{r}_{1}} {θ}_{out} ,$$
where θᵢₙ indicates the rotation angle of the inner meshing teeth, θₒᵤₜ indicates the rotation angle of the outer meshing teeth, r₁ indicates a radius of the center disc, and r₂ indicates a radial width of the hollow disc.

6. The rotary separator supply as claimed in claim 5, wherein a width of the inner meshing teeth is larger than a width of the outer meshing teeth.

7. The rotary separator supply as claimed in claim 1, wherein the driving member comprises a fastening end connected to a side portion of the disc structure, and a link structure coupled to the fastening end.

8. The rotary separator supply as claimed in claim 7, wherein the link structure comprises at least one of a crank-rocker link or a slide link.

9. The rotary separator supply as claimed in claim 7, wherein the disc structure comprises a plurality of disc structures that are aligned in parallel with each other in a horizontal direction, and
wherein the driving member further comprises a horizontal connecting link connecting the disc structures to each other in the horizontal direction, the horizontal connecting link being coupled to the fastening end to apply a same rotational force to each of the disc structures.

10. The rotary separator supply as claimed in claim 7, wherein the disc structure comprises a plurality of disc structures that are aligned in parallel with each other in a vertical direction as a vertically aligned group, and
wherein the driving member further comprises a vertical connecting link connecting the disc structures to each other in the vertical direction to form the vertically aligned group, the vertical connecting link being coupled to the fastening end to apply a same rotational force to each of the disc structures.

11. An electrode plate stacking apparatus comprising:
a rotary separator supply configured to rotate in a cycle, and supply a plurality of separators through a plurality of slots to fold the separators;
a plurality of stacking stages located below the slots, respectively, and configured to initially fix the separators passing through the slots; and
electrode plate supplies, each located at side portions of a corresponding stacking stage of the stacking stages and configured to alternately supply positive electrode plates and negative electrode plates to surfaces of a corresponding separator of the separators that is folded in a zigzag shape,
wherein the stacking stages are configured to receive a plurality of the positive electrode plates and a plurality of the negative electrode plates separated from each other by the separators and stacked thereon.

12. The electrode plate stacking apparatus as claimed in claim 11, wherein the rotary separator supply comprises:
a disc structure configured to rotate about a rotary shaft, and comprising the slots in a surface thereof;
a plurality of separator supply ends located above the disc structure, and configured to supply the separators to the slots, respectively; and
a driving member connected to the disc structure, and configured to reciprocally rotate the disc structure by a circumferential distance to repeatedly move the separators in a folding direction perpendicular to the slots.

13. The electrode plate stacking apparatus as claimed in claim 12, wherein the disc structure comprises:
a ring frame comprising first meshing teeth extending inward;
a hollow disc comprising outer meshing teeth configured to mesh with the first meshing teeth, inner meshing teeth on an inner open area to extend inward, and the slots; and
a center disc comprising second meshing teeth on outer portions and configured to mesh with the inner meshing teeth, the center disc being configured to close the inner open area and allow the rotary shaft to extend through a central portion thereof,
wherein a rotation angle of the outer meshing teeth with respect to a rotation angle of the inner meshing teeth is defined, so that the outer meshing teeth and the inner meshing teeth have a same circumferential distance as each other, according to:
$${θ}_{in} = \frac{{r}_{1} + {r}_{2}}{{r}_{1}} {θ}_{out} ,$$
where θᵢₙ indicates the rotation angle of the inner meshing teeth, θₒᵤₜ indicates the rotation angle of the outer meshing teeth, r₁ indicates a radius of the center disc, and r₂ indicates a radial width of the hollow disc.

14. The electrode plate stacking apparatus as claimed in claim 12, wherein the driving member comprises a fastening end connected to a side portion of the disc structure, and a link structure coupled to the fastening end.

15. The electrode plate stacking apparatus as claimed in claim 12, wherein the stacking stages comprise first to fourth stages aligned in a clockwise direction to be spaced from each other, and corresponding to first to fourth slots from among the plurality of slots that are spaced from each other at an angle of 90° and located sequentially in the clockwise direction, and
wherein the electrode plate supplies comprise:
a first supply located on opposite sides of the first stage, and configured to alternately supply the positive electrode plates and the negative electrode plates;
a second supply located on opposite sides of the second stage, and configured to alternately supply the positive electrode plates and the negative electrode plates;
a third supply located on opposite sides of the third stage, and configured to alternately supply the positive electrode plates and the negative electrode plates; and
a fourth supply located on opposite sides of the fourth stage, and configured to alternately supply the positive electrode plates and the negative electrode plates.

16. The electrode plate stacking apparatus as claimed in claim 15, further comprising:
a first positive electrode tray adjacent to the first stage and the fourth stage, and configured to supply the positive electrode plates concurrently to the first stage and the fourth stage;
a first negative electrode tray adjacent to the first stage and the second stage, and configured to supply the negative electrode plates concurrently to the first stage and the second stage;
a second positive electrode tray adjacent to the second stage and the third stage, and configured to supply the positive electrode plates concurrently to the second stage and the third stage; and
a second negative electrode tray adjacent to the third stage and the fourth stage, and configured to supply the negative electrode plates concurrently to the third stage and the fourth stage.

17. The electrode plate stacking apparatus as claimed in claim 12, wherein the electrode plate supplies comprise a synchronizer configured to synchronize an operation signal with the disc structure to supply one of the positive electrode plate or the negative electrode plate while the disc structure is rotating.

18. An electrode plate stacking method comprising:
supplying a plurality of separators concurrently through a plurality of slots of a rotatable disk structure;
initially fixing the separators, each of the separators corresponding to one of a plurality of stacking stages located below the slots;
rotating the disc structure forward by a folding angle to fold the separators concurrently with each other to cover the stacking stages;
supplying first electrode plates concurrently to first surfaces of the separators, respectively, while the separators are being folded;
rotating the disc structure backward by the folding angle to fold the separators concurrently with each other to cover the first electrode plates; and
supplying second electrode plates concurrently to second surfaces of the separators, respectively.

19. The electrode plate stacking method as claimed in claim 18, wherein the rotating of the disc structure forward, the supplying of the first electrode plates, and the rotating of the disc structure backward are performed concurrently with each other.

20. The electrode plate stacking method as claimed in claim 18, wherein the first electrode plates comprise positive electrode plates that are supplied concurrently to a pair of adjacent positive electrode supplies, and
wherein the second electrode plates comprise negative electrode plates that are supplied concurrently to a pair of adjacent negative electrode supplies.
